(19) United States
(12) Patent Application Publication
(10) Pub. No.: US 2004/0210642 A1
(43) Pub. Date: Oct. 21, 2004

(54) Method and system for caching data in a network node

(76) Inventors: Adisak Mekkittikul, Mountain View, CA (US); Nader Vijeh, Sunnyvale, CA (US)

Correspondence Address: Lantern Communications, Inc., 1246 Reamwood Avenue, Sunnyvale, CA, 94089, US

(21) Appl. No.: 10/845,656

(22) Filed: May 13, 2004

Related U.S. Application Data
(63) Continuation of application No. 09/879,276, filed on Jun. 11, 2001.

(51) Int. Cl. G06F 15/167; G06F 12/00

(52) U.S. Cl. 709/213; 711/119

(57) ABSTRACT

A method and system for efficiently, quickly, and economically buffering data in a network node. Incoming data from the network is received by the network node. This data is first temporarily stored in a tail cache. Blocks of incoming data are stored in the tail cache. When a predetermined number of N blocks of data are stored in the tail cache, a single write operation is initiated to write the N blocks of data from the tail cache to a section of main memory. When a head cache becomes empty, it requests data from the main memory. The predetermined number of N blocks of data from the main memory is transferred to the head cache in a single memory access operation. Eventually, the network node is allowed to transmit data onto the network, whereupon the head cache outputs its data onto the network. In the present invention, the tail cache and the head cache are comprised of relatively small, but fast SRAM memory; whereas the main memory is comprised of slower, but less expensive DRAM memory. By implementing this caching scheme, the super block of N blocks is always filled with data, thereby maintaining full space and bandwidth efficiencies at all times.

### FIELD OF THE INVENTION

The present invention relates to a method and system for caching data in a network node.

### BACKGROUND OF THE INVENTION

Communications networks are critical for carrying digital information. In order to meet the virtually insatiable demand imposed by Interment, IP telephony, video teleconferencing, e-commerce, file transfers, e-mail, etc., networks designers are striving to continuously increase network bandwidth. Indeed, fiber optic networks are now routinely handling bandwidths in excess of 10 Gbps (gigabytes per second). The manner by which digital information is conveyed through these networks entails breaking the digital data into a number of small “packets.” These packets of data are routed through the communications network via a number of routers, hubs, and/or switches which direct the flow of these data packets through the network.

In order to properly route the data packets, these network nodes would often temporarily have to “buffer” or store incoming data packets. Typically, the buffered data packets are stored in random access memory (RAM) chips. Random access performance is of particular importance in data networks since the destinations of arriving and departing data packets are extremely random in nature and because packets are often buffered separately according to their destination.

However, the bandwidth of networks is rapidly surpassing the rate by which data can be efficiently accessed from the random access memories. It is anticipated that memory speed will become a bottleneck in data networks since memory access rates have not kept up with the increased bandwidth of communications networks. During the last ten years, data networking bandwidth has increased by many orders of magnitude while memory storage access rates have increased by less than one order of magnitude.

One approach used to increase data buffering speed has been to simply use the fastest memory technology available. For example, many network nodes use static random access memory chips (SRAMs). Data can be written to and read from SRAMs relatively quickly. By comparison, data entry stored in SRAM can be randomly accessed as fast as 3 nanoseconds (ns) whereas the same entry may take 50-70 ns to access when stored in a more traditional dynamic random access memory (DRAM). Unfortunately, SRAM memory chips are prohibitively expensive because they are more complex to manufacture. Although SRAMs offer a speed increase of several times over the simpler, cheaper dynamic random access memory (DRAM) chips, the SRAMs cost approximately ten times that of DRAMs.

Another method of improving memory access entails widening the memory bus so that more bits can be read from and written to memory per clock cycle. However, this approach is not ideal for use in data networks. In data networks the minimum packet size to be transferred and transferred into a buffer memory may be as little as 44 bytes. Unfortunately, the minimum size of a data block to be transferred into memory can be no smaller than the width of the memory bus. Consequently, for a given small data packet size, an increase in the memory bus width only results in a decrease in the efficiency of data memory access. For data packets which are smaller than the block transfer size, memory bandwidth is underutilized and memory bandwidth is effectively limited.

Therefore, there is a need for a method and system for transferring data in and out of memory within a data network which is both fast, economical, and efficient. The invention described herein provides for such one such method and system.

### SUMMARY OF THE INVENTION

The present invention pertains to a method and system for efficiently, quickly, and economically buffering data in a network node. Incoming data from the network is received by the network node. This data is first temporarily stored in a tail cache. Blocks of incoming data can be stored in the tail cache. When a predetermined number of N blocks of data are stored in the tail cache, a single write operation is initiated to write the N blocks of data from the tail cache to a section of main memory. When a head cache becomes empty, it requests data from the main memory. The predetermined number of N blocks of data from the main memory is transferred to the head cache in a single memory access operation. The tail cache and the head cache are comprised of relatively small, but fast SRAM memory; whereas the main memory is comprised of slower, but less expensive DRAM memory. By implementing this caching scheme, the super block of N blocks is always filled with data, thereby maintaining full space and bandwidth efficiencies at all times.

### BRIEF DESCRIPTION OF THE DRAWINGS

The operation of this invention can be best visualized by reference to the following drawings described below.

FIG. 1 illustrates an embodiment of the invention as a network node upon a data network.

FIG. 2 is a flowchart describing the steps for transferring data in and out of memory of a network node.

FIG. 3 illustrates another embodiment of the invention as a memory or network node for buffering data on a computer network whereby the main memory is bypassed.

FIG. 4 is a flowchart describing the steps for transferring data directly from a tail cache to a head cache and bypassing the main buffer memory.

### DETAILED DESCRIPTION OF THE PREFERRED EMBODIMENTS

Described in detail below is a method and system for transferring data through a buffer memory on a computer network. In the following description, for purposes of explanation, numerous specific details are set forth in order to provide a thorough understanding of the present invention. It will be obvious, however, to one skilled in the art that the present invention may be practiced without these specific details. In other instances, well-known structures and devices are shown in block diagram form in order to avoid obscuring the present invention.

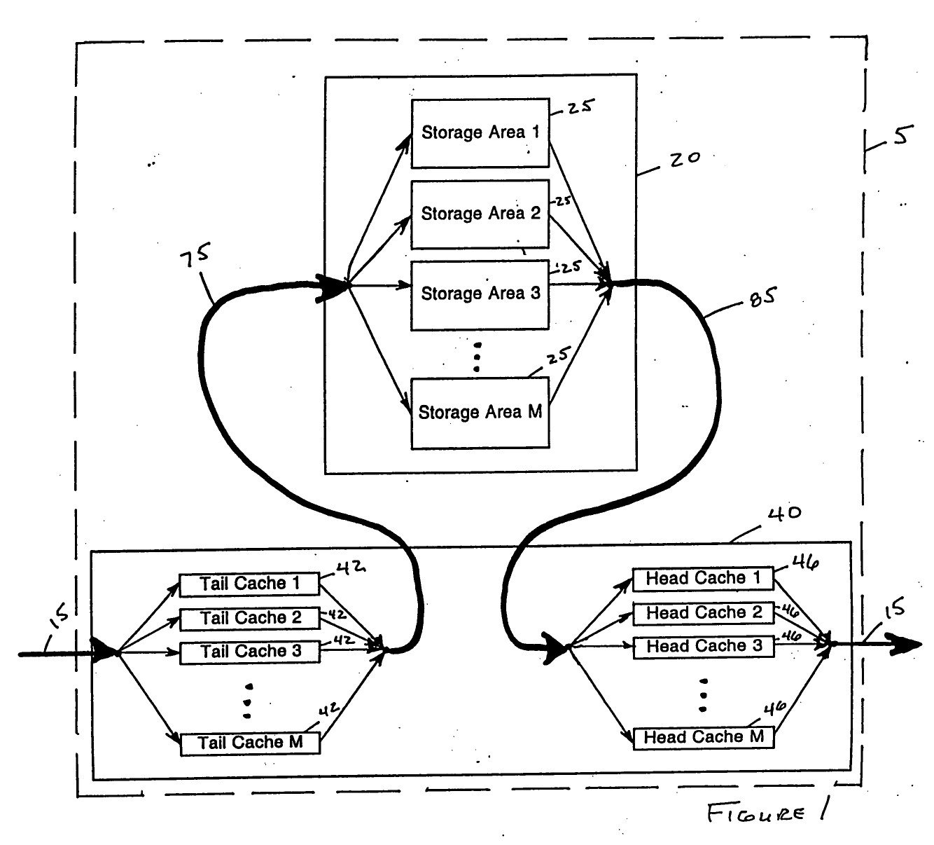

FIG. 1 illustrates an embodiment of the invention as a network node 5 upon a data network 15. Data network 15 conveys packetized data and has multiple such network nodes to aid in the routing of the data packets. The network node 5 includes a plurality of tail caches 42. It is the function of the M multiple tail caches to receive data packets incoming from the data network 15. This incoming data is initially temporarily stored in the tail caches 42. The tail caches are comprised of fast random access memory, such as SRAM chips. The network node 5 is further comprised of a main memory 20. Main memory 20 provides M multiple storage areas 25. A separate data storage area 25 within the main memory 20 is associated with each tail cache 42. Main memory 20 is comprised of less expensive memory, such as DRAM chips. Further comprised within network node 5 are multiple head caches 46. There is one head cache 46 associated with each tail cache 42 and each main memory storage area 25. Each head cache 46 receives data from the separate data storage area 25 associated with the tail cache 42. The function of head cache 46 is to output data from the network node 5 and onto the data network 15.

Referring further to FIG. 1 and the embodiment disclosed therein, the passage of the data through the network node 5 occurs by the storing of data incoming from network 15 to the M multiple tail caches 42. The data from the tail caches 42 then passes to the main buffer memory 20 via the write bus 75. Data passes out of the main buffer memory 20 to the head caches 46 via the read bus 85. Data is then available to be forwarded from the M multiple head caches onto and further along the network 15 when data transfer capacity becomes available on network 15.

Although physically separated, the tail caches 42, main memory storage areas 25, and head caches 46, all act logically as a single first-in-first-out (FIFO) queue. In one embodiment, there is one tail, one main memory buffer, and one tail associated with each data flow. A data flow may consist of a particular communications application, particular user, or some other means of identification and/or classification.

In the currently preferred embodiment, the tail caches 42, main memory storage areas 25, and head caches 46 are organized into blocks of fixed size. Each arriving packet is first written into the corresponding tail cache according to the flow to which it belongs. The tail cache waits until there are N blocks worth of data packets before moving the data into the main memory. This allows the effective memory transfer size to be N times larger than a minimum packet size without wasting bandwidth or space of the memory. Similarly, when a head cache becomes empty, it fetches N blocks of data from the main DRAM memory 20. Thereby, the super block of N blocks is always filled with data (i.e., payload on both write and read operations), maintaining full space and bandwidth efficiencies at all time.

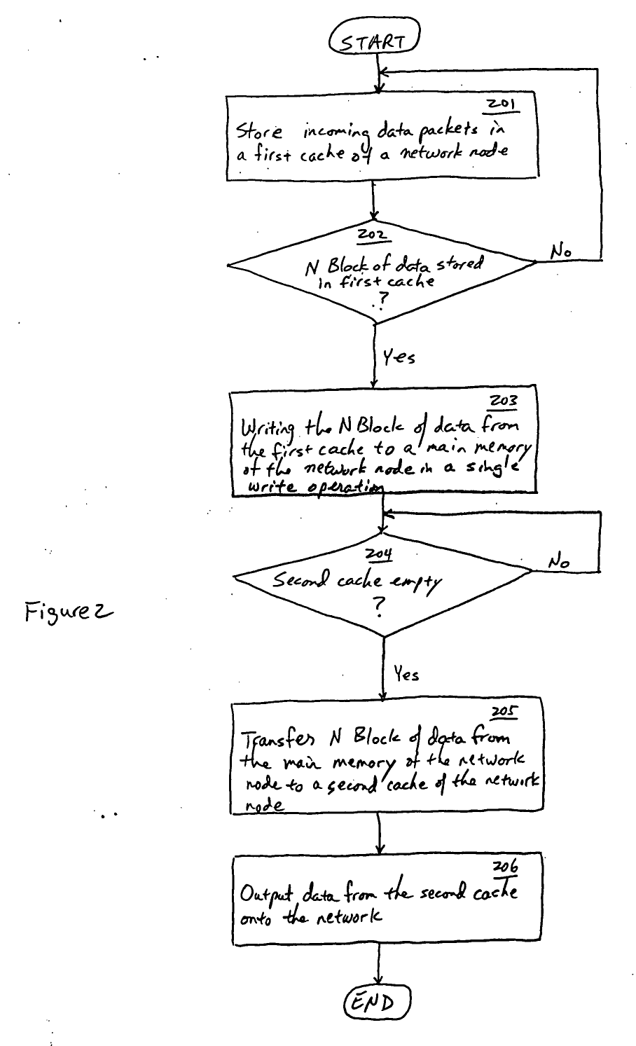

FIG. 2 is a flowchart describing the steps for transferring data in and out of memory of a network node, in accordance with one embodiment of the present invention. The process begins with step 201 of receiving data incoming to the network node. This data is stored in a first cache until a predetermined amount of data is received, step 202. Next in step 203, the predetermined amount of data from the first cache is moved to a main memory buffer. In a preferred embodiment of the invention, the moving of the data from the first cache to the main memory buffer is performed in a single write operation. The process then waits until a second cache is emptied, step 204. When a second cache is empty, the quantity of data of the predetermined amount is moved from the main memory buffer to the second cache, step 205. Eventually, this data is output from the second cache onto the network. The method 200 thus allows for the first cache, main memory buffer, and second cache to act logically together as a single FIFO (first-in-first-out) queue. And in a preferred embodiment, the moving of the data from the main memory buffer to the second cache in step 205 is performed in a single read operation. When the second cache is empty, it reads the corresponding block of data from the main memory buffer. In the currently preferred embodiment, the transfer of data from the first cache to the main memory buffer and the subsequent transfer of data from the main memory buffer to the second cache are such that the superblock or N data blocks are filled or nearly filled and the width of the memory bus is fully utilized. Eventually, data is output from the second cache onto the data network.

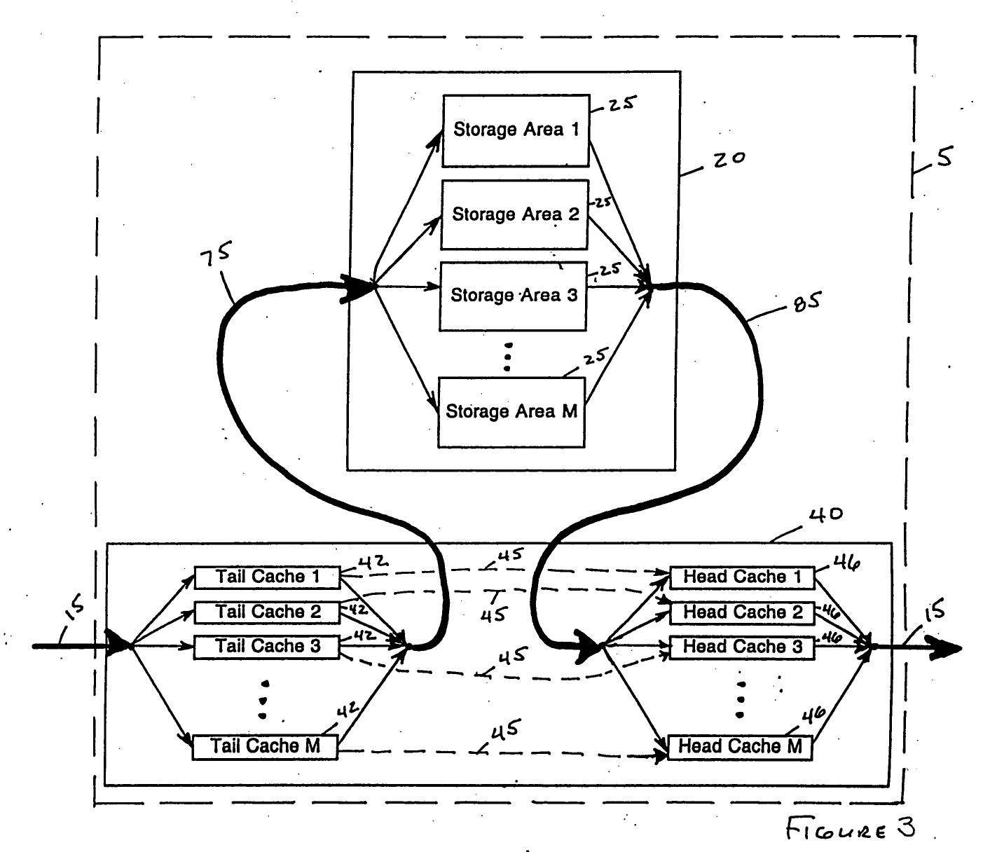

FIG. 3 illustrates another embodiment of the invention as a memory or network node for buffering data on a computer network. The features of this embodiment are the same as those referred to in FIG. 1 but the network node 5 has the additional feature of providing data paths 45 directly between each tail cache 42 and each associated head cache 46. Data paths 45 allow for the direct tail cache to head cache forwarding of data. In other words, head cache 46 may draw data directly from the tail cache 42. If a particular main buffer memory storage area 25 contains no data, the corresponding head cache 46 can request the corresponding tail cache 42 to forward its data directly via data path 45. This embodiment of the invention provides a means for the tail cache data to be transferred to the head cache directly without having it be stored within main buffer memory 20 at any time. By directly forwarding data from the tail cache to the head cache, data throughput from the network node can be improved.

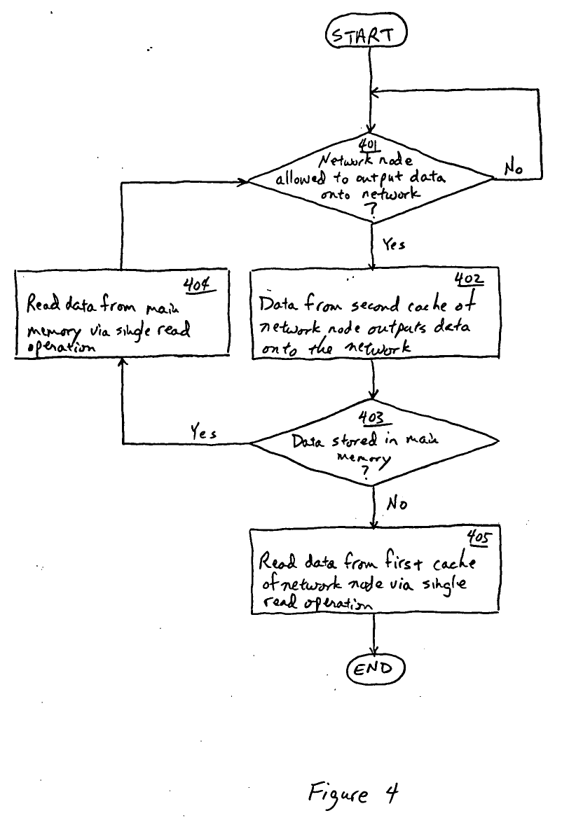

FIG. 4 is a flowchart describing the steps for transferring data directly from a tail cache to a head cache and bypassing the main buffer memory. The network node waits until it is allowed to transmit data onto the network, step 401. When it is allowed to output data onto the network, the second cache (e.g., the head cache) is emptied onto the network, step 402. The data storage area of the main buffer memory corresponding to that particular second cache is then checked to determine whether it contains data, step 403. If it contains data, then that data is read in a single read operation and stored into the second cache, step 404. However, if the corresponding data storage area does not contain data, then data is read directly from the corresponding first cache memory, step 405. A single read operation is used to read data from the first cache memory and directly store that data in the second cache memory. Thereby, the main buffer memory is bypassed.

Thus, a high speed network data caching process is disclosed. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. In a computer network having a plurality of network nodes, a method for caching data within the network node comprising the steps of:
receiving data packets incoming from said network;
storing said data packets in a first cache until a predetermined amount of data is received;
transferring said predetermined amount of data in said first cache to a main memory in a single memory operation; and
transferring said predetermined amount of data from said main memory to a second cache in a single memory operation.

2. The method of claim 1 further comprising the step of forwarding data packets out of said network node from said second cache onto said network.

3. The method of claim 1, wherein said predetermined amount of data is comprised of N blocks of data and the size of said block corresponds to a minimum data packet size.

4. The method of claim 1 wherein said first cache, said main memory, and said second cache act logically as a single first-in-first-out queue.

5. The method of claim 1, wherein said data incoming to said memory is comprised of M data flows and said network node is comprised of M multiple first caches, M multiple data storage areas within said main memory buffer, and M multiple second caches.

6. The method of claim 1, wherein the first cache, the main memory, and the second cache are comprised of random access memory.

7. The method of claim 6, wherein the first cache is comprised of SRAM, the main memory is comprised of DRAM, and the second cache is comprised of SRAM.

8. The method of claim 1 further comprising the step of transferring data directly from the first cache to the second cache and bypassing the main memory.

9. At network element for coupling to a data network, comprising:
a first cache which stores data received by the network element;
a main memory coupled to the first cache, wherein data from the first cache is written to the main memory;
a second cache coupled to the main memory, wherein data from the main memory is written to the second cache for output onto the network.

10. The network element of claim 9 wherein said first cache stores N blocks of data until a given set of N blocks of data are stored whereupon the given set of N blocks of data are transferred to the main memory in a single memory access operation.

11. The network element of claim 10, wherein the given set of N blocks of data stored in the main memory are transferred to the second cache in a single memory access operation.

12. The network element of claim 11 further comprising a plurality of first caches, a plurality of separate storage areas in said main memory, and a plurality of second caches.

13. The network element of claim 9, wherein said first cache comprises SRAM, said main memory comprises DRAM, and said second cache comprises SRAM.

14. The network element of claim 9, wherein said second cache may request data be transferred directly from the first cache.
